(19) United States
(12) Patent Application Publication
(10) Pub. No.: US 2012/0166399 A1
(43) Pub. Date: Jun. 28, 2012

(54) AUTOMATED ROLE CLEAN-UP

(76) Inventors: RAVIKANTH ERUKULLA, Milpitas, CA (US); Qingtong Yan, Palo Alto, CA (US)

(21) Appl. No.: 12/978,665

(22) Filed: Dec. 27, 2010

(51) Int. Cl. G06F 17/00

(52) U.S. Cl. 707/692; 707/E17.007

(57) ABSTRACT

Various embodiments of systems and method automated role clean-up are described herein. In various embodiments, an automated role clean-up agent can connect to a role repository system that may be configured to implement an automated role clean-up workflow. A method of an embodiment ensures that roles that are not being used or outdated are safe to delete. One or more deletion buffers may be configured to determine whether roles need to be deleted from the role repository system. Assigning conditions to a deletion buffer lets roles to be incubated in these deletion buffers for a desired period of time before deletion if the conditions are met. A re-affirmation can be sent out to role owners for deletion approval before roles are deleted. Deletion of the roles is performed by the role repository system.

### TECHNICAL FIELD

The field generally relates to role clean-up in enterprises, and more specifically to a system and method for automated role clean-up in enterprise software.

### BACKGROUND

Role maintenance is often a challenging and time consuming task for corporations since roles tend to become out dated if not properly monitored. For example, roles in an ERP system may either get out of context or out of date for the current environment. Thus, new roles have to be created. This is particularly true for larger corporations that go through an acquisition or a merger. The end result is an overwhelming volume of roles that need further investment to be maintained. Furthermore, roles cannot simply be deleted. There is no straight forward way to identify roles for deletion. There is always an alarm that some roles might currently be in use, and if deleted, might cause further repercussions or serious issues affecting a line of business.

Manual deletion of roles can take time and effort to complete. Since administrators of a role repository system commonly have permission for role deletion, a system may have many administrators. Role deletion may also involve manual synchronization of who deleted which roles and why. A method of synchronizing appropriate personnel would vastly improve transparency and the statuses of each role. An automated process that identifies roles that need to be deleted, ensures that these roles are no longer in use, and allows a clean and safe method of cleaning them from a role repository system would also improve and optimize role maintenance. Such an automated process can lower cost of role maintenance, focus more on actual roles that are needed which in turn may yield better return on investment, and keep the quantity of roles to a minimum.

### SUMMARY

Various embodiments of systems and methods for automated role clean-up are described herein.

Described herein is an automated role clean-up of roles from any type of Enterprise Resource Planning or role repository system. In one aspect, a connection is established to a role repository system. One or more deletion buffers are configured with at least one condition to determine whether one or more roles need to be deleted from the role repository system. In yet another aspect, a retrieval of one or more roles from the role repository system is performed, in which, the one or more roles are buffered through the one or more deletion buffers. A notification can be sent informing a progress of the one or more roles through a role clean-up workflow. Once buffered through the one or more deletion buffers, the one or more roles are sent to a deletion basket. In a further aspect, a re-affirmation may be received from the role owner to approve the deletion of the one or more roles and a deletion of the one or more roles is then performed.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an automated role clean-up agent according to various embodiments.

FIG. 2 is a flow diagram illustrating an exemplary method of a role clean-up workflow according to various embodiments.

FIG. 3A is a flow diagram illustrating an exemplary method of a first part in a role clean-up workflow using two deletion buffers according to various embodiments.

FIG. 3B is a flow diagram illustrating an exemplary method of a second part in a role clean-up workflow using two deletion buffers according to various embodiments.

FIG. 4 is a block diagram of an exemplary computer system according to various embodiments.

### DETAILED DESCRIPTION

Embodiments of techniques for automated role clean-up are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

In various embodiments, the system and method for automated role clean-up is a configurable agent that allows clean-up of unused, out-of date, unintended, or unnecessary roles. The agent is generic and can be connected to any type of Enterprise Resource Planning (ERP) system or role repository system (RRS). A role clean-up workflow can be defined by configure the agent to specific needs and extend the configuration to as many workflow stages as needed. The agent can be integrated to a role repository system with external services on a buffering level and a deletion level. The buffering level allows integration of configured deletion buffers and the deletion level allows the native system or role repository to handle the deletion of roles.

In various embodiments, workflow stages may be defined. A deletion buffer stores roles to be deleted. Each deletion buffer may be configured by assigning conditions that lets roles to be incubated in these deletion buffers for a desired period of time before deletion. Whenever a role meets a condition of a deletion buffer and is ready to be moved to a deletion basket, the automated role clean-up agent sends a re-affirmation to a role owner for deletion approval. Following an approval, the roles are sent to the deletion basket for deletion.

In various embodiments, the automated role clean-up agent may provide specific work flow services during a role clean-up process. When configured, a buffering agent allows the possibility to create as many deletion buffers as needed to make sure that the roles to be deleted have fully met the defined conditions and are safe to delete. Since the automated role clean-up agent supports multiple deletion buffers and the role to be deleted should move into the deletion basket before it is deleted, a workflow agent will control when and how the roles will be moved from deletion buffer to deletion buffer, deletion buffer to deletion basket, or from deletion buffer back to the role repository system. While actions are taken during the role clean-up workflow, such as, to move a role from deletion buffer to deletion buffer, or to a deletion basket, notifications can be sent to notify a progress of the roles in question. Configuring a notification agent can determine to whom and when a notification should be sent.

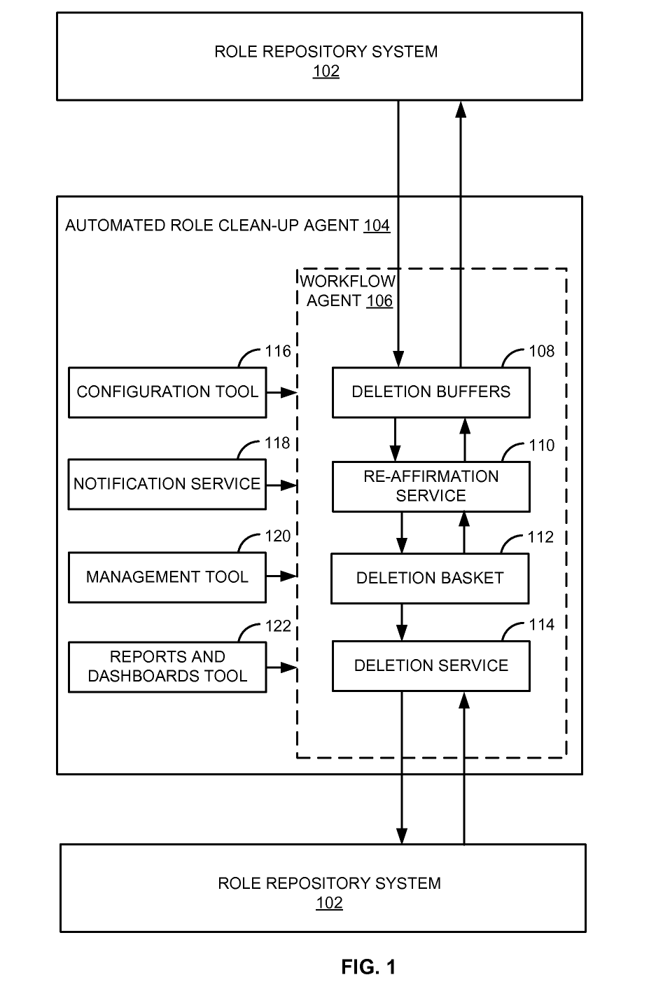

FIG. 1 is a block diagram illustrating an automated role clean-up agent according to various embodiments. Referring to FIG. 1, an automated role clean-up agent 104 uses external integration services to connect to a role repository system 102 to retrieve one or more roles. Once retrieved, they are processed through a workflow agent 106. In other words, a workflow agent 106 is a role clean-up workflow or a process which a role goes through before deletion. The workflow agent 106 comprises one or more deletion buffers 108 that may be configured to buffer roles that are to be deleted if the role meets the conditions defined in the deletion buffers 108. The workflow agent 106 further comprises a re-affirmation service 110 that is used to request an approval for a role deletion by a role owner of that specific role. If a re-affirmation is approved, a deletion basked is used to store roles that are ready to be deleted. The workflow agent 106 also contains a deletion service 114 that is requested by the automated role clean-up agent 104 from the role repository system 102 to delete the stored roles. A role repository system 102 may also request the automated role clean-up agent 104 to send all roles to be deleted that have been stored in the deletion basket 112.

An automated role clean-up agent 104 is made up of separate tools and services that assist in configuring a workflow agent 106. The automated role clean-up agent 104 consists of a configuration tool 116 that provides the flexibility to customize a role clean-up workflow strategy for a role repository system 102. The configuration tool 116 can be used to create deletion buffers 108 and to configure specific conditions for each deletion buffer. It may also be used to check or validate conditions of deletion buffers. A management tool 120 is also available which provides system level management. This may include setting up a connection to a specified role repository system 102, high level management of who may have permission to access automated role clean-up agent 104, and other such system level management tasks.

In order to monitor role deletion, a reports and dashboard tool 122 allows the monitoring of how many roles are contained within each deletion buffer 108, how many are waiting to be processed through the workflow agent 106, how many roles have been sent back to the role repository system 102, and other such reports. With the processing of each role, a notification service 118 is used and configured to track where a role is in a workflow agent 106. The notification service 118 configuration includes the recipient of the notification and while a notification can be sent to an individual role, it can be sent out for all roles. Notifications can be sent to individuals who are interested in the status change of the role from deletion buffer to deletion buffer, from deletion buffer to deletion basket, the deletion of the role, or even a role being sent back to the role repository system 102.

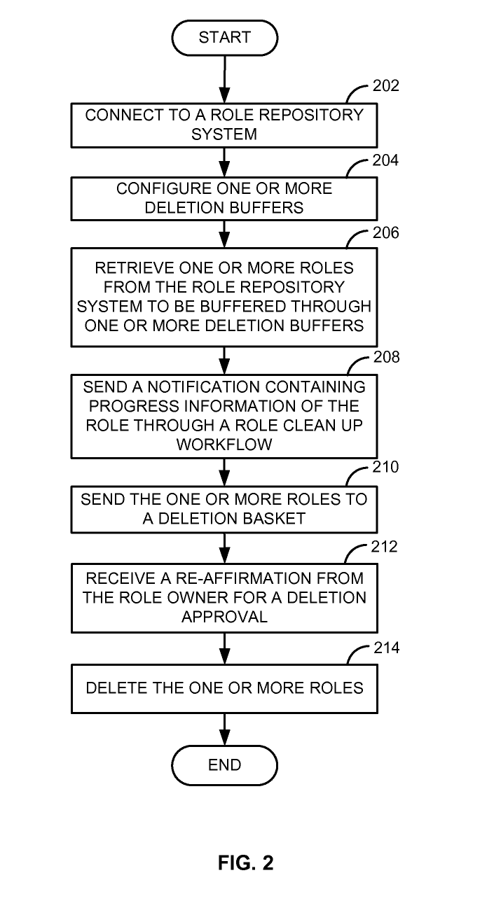

FIG. 2 is a flow diagram illustrating an exemplary method of a role clean-up workflow according to various embodiments. Referring to FIG. 2, at process block 202, an automated role clean-up agent establishes a connection to a role repository system. As in process block 204, one or more deletion buffers can be configured by defining conditions in which to buffer a role if the role meets a condition. The automated role clean-up agent retrieves one or more roles from the role repository system, at process block 206, and buffers them one at a time. The automated role clean-up agent can be used to configure the conditions in which a role enters or exits a deletion buffer, movement of a role between the deletion buffers and the role repository system, movement of a role between deletion buffers, or even movement of a role straight to a deletion basket once it is retrieved from the role repository system. For example, in case of having five deletions buffers, a main path of a role in a role clean-p workflow will be from deletion buffer 1 to deletion buffer 2, deletion buffer 3, deletion buffer 4, deletion buffer 5, and deletion basket. A sub path can be any sequential movement of a role through the deletion buffers depending on at which deletion buffer the role enters. The main path should always be enabled, but if the other sub paths do not make sense from a business perspective, then the conditions can be configured to where only the main path and a specified sub path is enabled.

Throughout a clean-up process, a notification can be sent, as in process block 208, containing progress information of a role. In other words, the location of a role in a role clean-up workflow. Typical recipients of notifications can be an administrator of the role repository system, an administrator of each of the deletion buffers and the deletion basket of the automated role clean-up agent, and a role owner. Once a role has sequentially moved through the one or more deletion buffers, the role is sent to the deletion basket, as in process block 210. In process block 212, a re-affirmation is received from the role owner to approve the deletion of the one or more roles. Once the approval is received, the one or more user roles are deleted, as in process block 214.

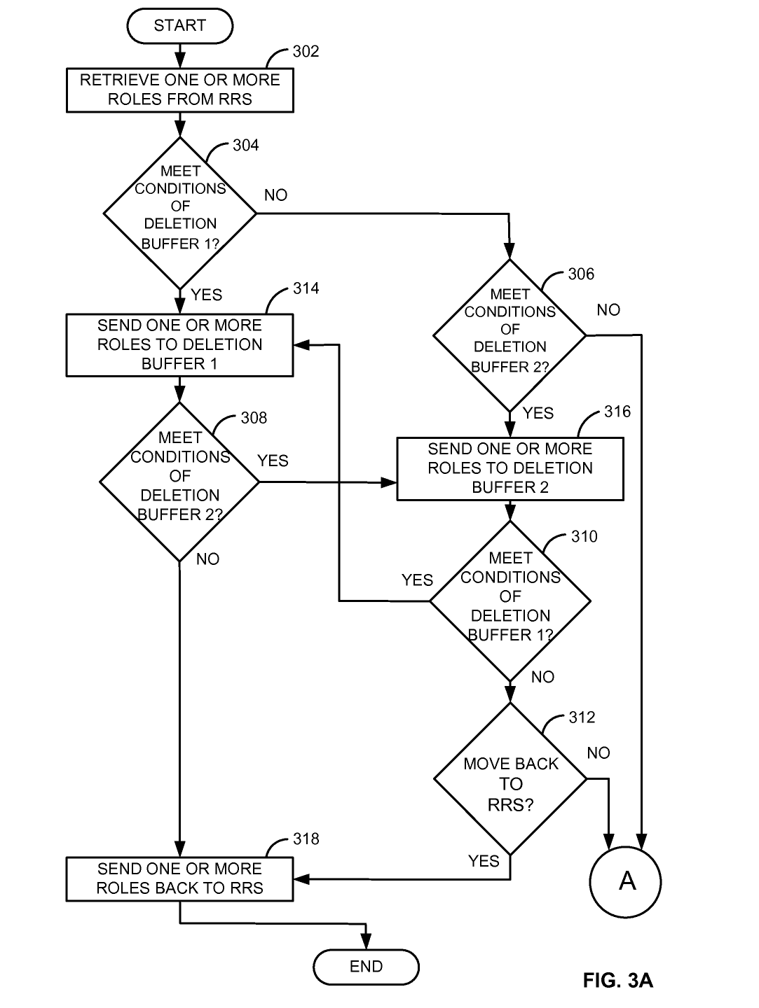

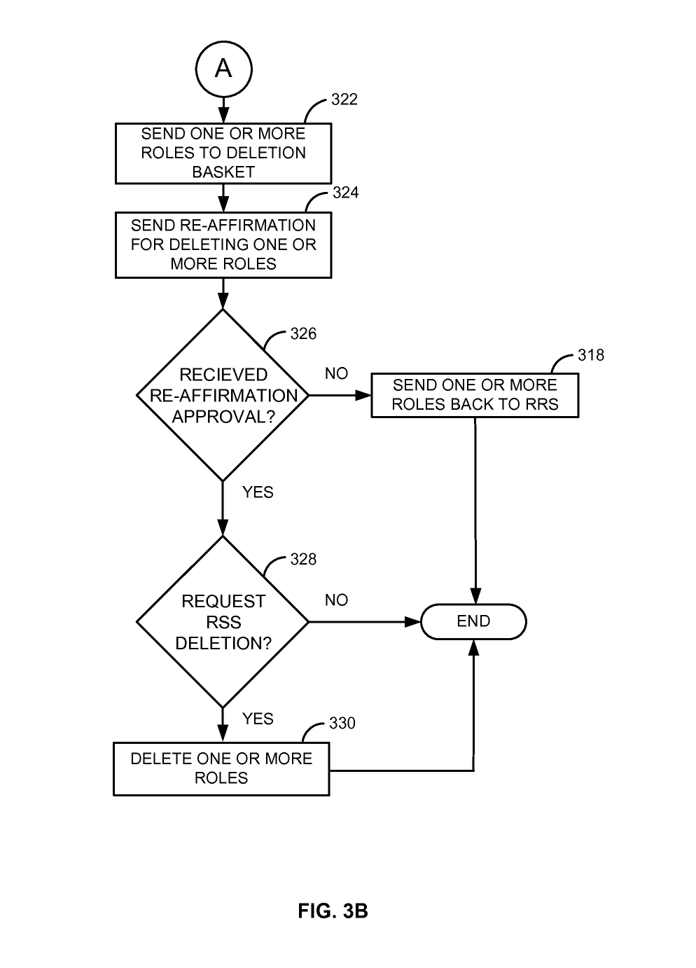

FIG. 3A is a flow diagram illustrating an exemplary method of a first part in a role clean-up workflow using two deletion buffers according to various embodiments. In various embodiments, the process as described in FIGS. 3A and 3B may be performed by components as described in FIG. 1. Referring to FIG. 3A, at process block 302, the automated role clean-up agent retrieves one or more roles from the role repository system (RSS). If the one or more roles meet the conditions of deletion buffer 1, at process block 304, then the one or more roles are sent to deletion buffer 1, such as in process block 314. Sequentially, the one or more roles, would in turn, need to meet the conditions of deletion buffer 2. If the conditions of deletion buffer 2 are met, as in process block 308, then the one or more roles are sent to deletion buffer 2, as such in process block 316. If the conditions are not met, then the one or more roles are sent back to the role repository system (RSS), as in process block 318.

Referring back to process block 304, if the one or more roles do not meet the deletion buffer 1 conditions, then second decision should be made concerning the conditions of the deletion buffer 2. If the one or more roles meet the conditions of deletion buffer 2, as in process block 306, then the one or more roles are sent to deletion buffer 2, as such in process block 316. An optional decision can be configured to whether the one or more roles meet the conditions of deletion buffer 1, as in process block 310, but is not mandatory. This can cycle the one or more roles through deletion buffer 1 to achieve a more thorough check of the one or more roles. Otherwise, the one or more roles then need be processed to whether they should be moved back to the role repository system (RSS), as such in process block 312. If so, then the one or more roles are sent back to the role repository system (RSS), as in process block 318.

FIG. 3B is a flow diagram illustrating an exemplary method of a second part in a role clean-up workflow using two deletion buffers according to various embodiments. In various embodiments, the process as described in FIG. 3 may be performed by components as described in FIG. 1. Referring back to process block 306 and 312 of FIG. 3A, if one or more roles do not meet the conditions of deletion buffer 2 at process block 306, or do not need to move back to the role repository system (RSS) at process block 312, then the one or more roles are sent to the deletion basket, as in process block 322. Upon entering the deletion basket, a re-affirmation is sent out to the role owners of the one or more roles for deletion approval, as in process block 324. If a re-affirmation approval is not received at process block 326, then the one or more roles are sent back to the role repository system (RSS) as in process block 318. Otherwise, upon receiving a deletion approval the automated role clean-up agent will request the role repository system (RSS) to perform a deletion, at process block 328. Deleting one or more roles, as in process block 330, may occur by two methods. Either the automated role clean-up agent requests an external service by the role repository system to perform a role deletion or the role repository system may request the automated role clean-up agent to send the roles for deletion.

In various embodiments, a system and method for automated role clean-up described herein may have a number of benefits. For example, one benefit is identifying roles that need to be deleted and ensuring that the roles are no longer in use. This is done by the deletion buffers in a role clean-up workflow. The configuring of deletion buffers and assigning conditions to each of the buffers allows roles to be incubated in these deletion buffers for a desired period of time before deletion, which in turn, provides assurance that the appropriate roles will be deleted. Sending notifications to appropriate recipients of the progress of a role in a role clean-up workflow offers transparency to a specified recipient of where the role is, as well as, offering transparency among recipients so that multiple recipients are informed of where a role is in a role clean-up workflow. Furthermore, authorization for a role deletion is only given by a role owner by approving a re-affirmation. This offers assurance that only one person can delete a specified role. Such an automated process can lower cost of role maintenance, focusing more on actual roles that are needed which in turn gives better return on investment, and keeps the quantity of roles to a minimum, simultaneously improving and optimizing role maintenance.

The tools that are available in an automated role clean-up agent are also of a major benefit. A report and dashboard tool offers maximum transparency of where the roles are in the role clean-up workflow. Monitoring of how many roles are contained within each deletion buffer, how many are waiting to be processed, how many roles have been sent back to the role repository system are all available to be analyzed in one place. The management tool provides setting up a connection to a specified role repository system, high level management of who may have permission to access automated role clean-up agent, and other such system level management tasks. Finally, the configuration tool provides flexibility to customize a role clean-up workflow strategy for a role repository system. It can be used to create deletion buffers and to configure specific conditions for each deletion buffer. The configuration tool may also be used to check the validity of the defined conditions of each deletion buffer.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

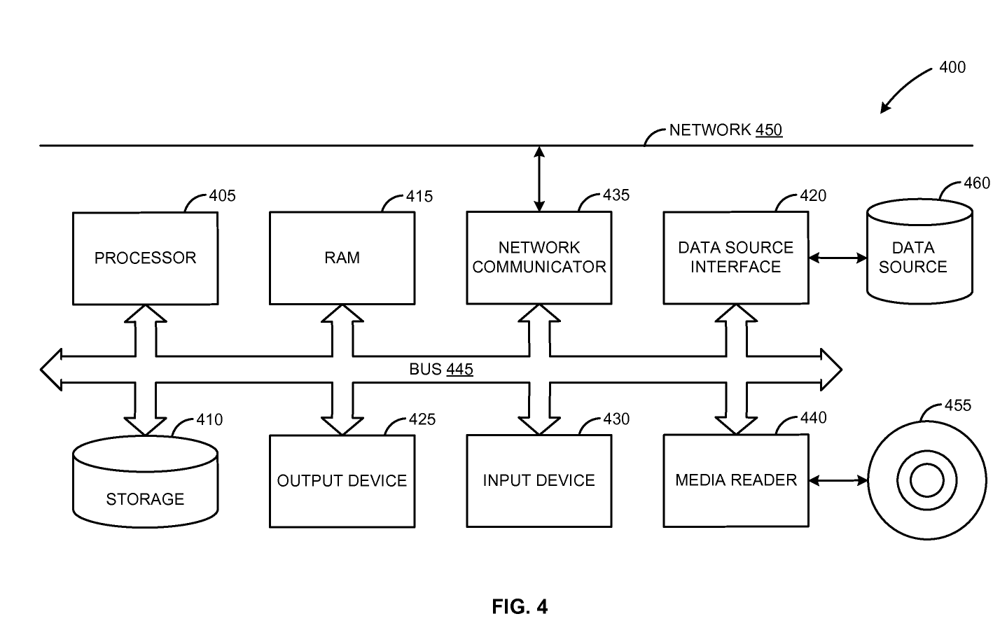

FIG. 4 is a block diagram of an exemplary computer system 400. The computer system 400 includes a processor 405 that executes software instructions or code stored on a computer readable storage medium 455 to perform the above-illustrated methods of the invention. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a tangible computer readable storage medium to physically store instructions, which when executed by a computer, cause the computer to:
connect to a role repository system;
configure one or more deletion buffers;
retrieve one or more roles from the role repository system to be buffered in the one or more deletion buffers;
send a notification, wherein the notification containing progress information of the one or more roles through a role clean-up workflow;
send the one or more roles for deletion to a deletion basket;
receive a re-affirmation from a role owner for a approval of the deletion of the one or more roles; and
delete the one or more roles.

2. The article of manufacture of claim 1, wherein configuring the one or more deletion buffers comprises configuring at least one condition to determine whether the one or more roles are to be deleted.

3. The article of manufacture of claim 1, further comprising configuring a workflow agent, wherein the workflow agent controls a progress of the one or more roles through the role clean-up workflow.

4. The article of manufacture of claim 1, wherein sending the notification further comprises configuring a notification service.

5. The article of manufacture of claim 1, wherein deleting the one or more roles comprises requesting the role repository system to perform a role deletion of the one or more roles.

6. The article of manufacture of claim 5, further comprising receiving a request from the role repository system to send the one or more roles for deletion.

7. A computerized method for automated role clean-up, the method comprising:
connecting to a role repository system;
configuring one or more deletion buffers;
retrieving one or more roles from the role repository system to be buffered in the one or more deletion buffers;
sending a notification, wherein the notification includes progress information of the one or more roles through a role clean-up workflow;
sending the one or more roles for deletion to a deletion basket;
receiving a re-affirmation from a role owner for a approval of the deletion of the one or more roles; and
delete the one or more roles.

8. The computerized method of claim 7, wherein configuring the one or more deletion buffers comprises configuring at least one condition to determine whether the one or more roles are to be deleted.

9. The computerized method of claim 7, further comprising configuring a buffering agent.

10. The computerized method of claim 7, wherein sending the notification comprises configuring a notification service.

11. The computerized method of claim 7, further comprising configuring a workflow agent, wherein the workflow agent controls a progress of the one or more roles through the role clean-up workflow.

12. The computerized method of claim 7, further comprising:
sending the one or more roles for deletion back to the role repository system if the one or more roles do not meet at least one condition configured for the one or more deletion buffers; and sending the one or more roles for deletion back to the role repository system if the role owner does not approve the re-affirmation.

13. The computerized method of claim 7, wherein deleting the one or more roles comprises requesting the role repository system to perform the role deletion function of the one or more roles.

14. The computerized method of claim 13, further comprising receiving a request from the role repository system to send the one or more roles for deletion.

15. A computerized system, including a processor, the processor communicating with a memory storing instructions, the instructions comprising:
an integration service to connect to a role repository system;
one or more deletion buffers to be configured for determining whether one or more roles are to be deleted;
a notification service, wherein the notification service includes a progress of the one or more roles through a role clean-up workflow;
a deletion basket to temporarily store the one or more roles for deletion;
a re-affirmation service to request a role owner for a deletion approval of the one or more roles; and
a deletion service to delete the one or more roles.

16. The computerized system of claim 15, wherein the one or more deletion buffers further comprises a buffering agent.

17. The computerized system of claim 15, further comprising a workflow agent, wherein the workflow agent controls the progress of the one or more roles through the role clean-up workflow.

18. The computerized system of claim 15, wherein the notification service comprises a list of recipients to receive a notification of the progress of the one or more roles through the role clean-up workflow.

19. The computerized system of claim 15, wherein the deletion service comprises a request to be received from the role repository system to send the one or more roles for deletion.

20. The computerized system of claim 19, further comprising the deletion service to request the role repository system to perform a deletion of the one or more roles.
